(19) United States
(12) Patent Application Publication
(10) Pub. No.: US 2006/0265594 A1
(43) Pub. Date: Nov. 23, 2006

(54) Documentation of service measures on a motor vehicle

(75) Inventors: Burkhard Kuhls, Stadtbergen (DE); Harry Knechtel, Berglern (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke, Muenchen (DE)

(21) Appl. No.: 11/493,569

(22) Filed: Jul. 27, 2006

Related U.S. Application Data
(63) Continuation of application No. PCT/EP04/02401, filed on Mar. 9, 2004.

(51) Int. Cl. H04L 9/00

(52) U.S. Cl. 713/176

(57) ABSTRACT

A method, device, and computer program product for documentation of service measures on a motor vehicle using an electronic memory are provided. The method for documentation of service measures on a motor vehicle using an electronic memory, includes generating a hash value of an input data specifying at least one concrete service measure, encrypting the hash value with a personal key as part of a public key method and entering into the electronic memory the input data, the encrypted hash value and a certificate containing in plain text at least the public key complementary to the personal key and data on the key holder.

### CROSS REFERENCE TO RELATED APPLICATIONS

This application claims priority under 35 U.S.C. § 120 to International Patent Application No. PCT/EP2004/002401 filed Mar. 9, 2004, the entire disclosure of which is herein expressly incorporated by reference.

### BACKGROUND AND SUMMARY OF THE INVENTION

The invention relates in particular to a method, device and computer program product for documentation of service measures on a motor vehicle using an electronic memory.

The use of “vehicle checkbooks” to document maintenance work performed on a particular vehicle is known.

This invention relates in particular to the problem of providing a reliable method for documentation of service measures performed on a motor vehicle using an electronic memory. Advantageous embodiments of the invention are described below.

Other objects advantages, and novel features of the present invention will become apparent from the following detailed description of the invention when considered with the accompanying drawings.

### BRIEF DESCRIPTION OF THE DRAWINGS

FIG. 1 illustrates an exemplary embodiment of a method in accordance with the present invention;

FIG. 2 illustrates another exemplary embodiment of a method in accordance with the present invention; and

FIG. 3 illustrates an exemplary embodiment of a device in accordance with the present invention.

### DETAILED DESCRIPTION OF THE DRAWINGS

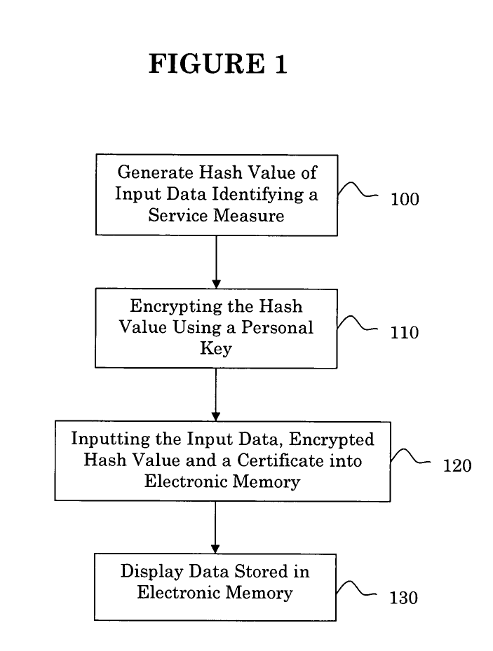

FIG. 1 illustrates an exemplary embodiment of a method in accordance with the present invention. An important aspect of the inventive process consists in a first step (Step 100) of generating a hash value of an input, which represents at least one concrete service measure, which may be in plain text. Those skilled in the art are familiar with various methods of generating hash values, which therefore need not be explained in greater detail here. This service measure may be an oil change, for example, replacement of parts subject to wear and/or a vehicle inspection.

In a second step (Step 110), the hash value of the input may be encrypted with a personal key using a public key method and may be assigned to the input and/or stored with it in the electronic memory.

In a third step (Step 120), the input for the service measure, which may be in plain text, the encrypted hash value and a certificate of the key holder are entered into, i.e., saved in the electronic memory. The certificate may contain at least the public key complementary to the personal key plus details regarding the key holder. As described below, the method illustrated in FIG. 1 may further include a step (Step 130) of displaying the data stored in the electronic memory.

In one embodiment of the invention, the encrypted hash value is stored in such a way that it cannot be replaced by another hash value.

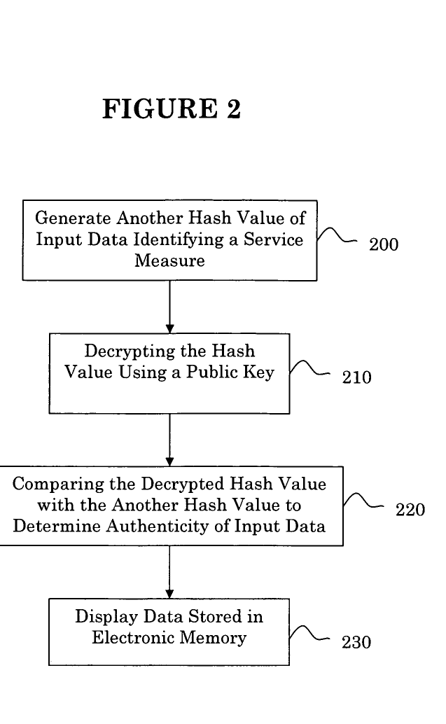

FIG. 2 illustrates another exemplary embodiment of a method in accordance with the present invention. Another important aspect of the invention consists of the fact that in a fourth step (step 200), the hash value for the input specifying the concrete service measure may be generated to check on the authenticity of the input. In a fifth step (Step 210), the encrypted hash value entered into the electronic memory is decrypted using the public key specified in the certificate. In a sixth step (Step 220), the decrypted hash value may be compared with the newly generated hash value. If the two hash values match, then the input is considered to be authentic. As described below, the method illustrated in FIG. 2 may further include a step (Step 230) of displaying the data stored in the electronic memory.

In one embodiment of the invention, the hash value is a bit cross-check sum, in particular a bit cross-check sum of the input data for the concrete service measure. This can be implemented in a technically uncomplicated manner, e.g., by a device in the vehicle that generates a hash value of the input such as a bit cross-check sum.

As an alternative or in addition, as the input data for the concrete service measure in one embodiment of the invention, the current date and the current kilometer reading on the vehicle at the point in time of the service measure and the hash value at least for the input data, including the date and the kilometer reading, are stored in the electronic memory.

Although the input data characterizing the status of a vehicle could easily be manipulated, this is very effectively prevented by the hash value at least for the input data identifying the service measure, the date and the kilometer reading.

As an alternative or in addition, in another embodiment of the invention, an electronic memory is provided in the vehicle, e.g., in a control unit in the vehicle and/or in a removable mobile data medium in the vehicle. For example, the electronic memory may be provided in a chip card and/or in a device outside of the vehicle, in particular by the manufacturer of the vehicle.

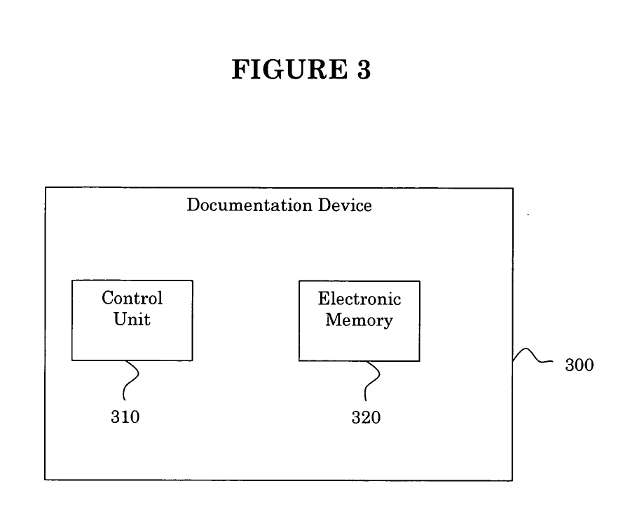

FIG. 3 illustrates an exemplary embodiment of a device in accordance with the present invention. A documentation device 300 of a motor vehicle may include a control unit 310 and an electronic memory 320. The control unit 310 may be configured to generate a hash value of input data which identifies at least one concrete service measure and encrypt the hash value using a personal key as part of a public key. The electronic memory 320 may be configured to store the input data, the encrypted hash value and a certificate containing in plain text at least the public key complementary to the personal key and data on a key holder.

With regard to the use of an electronic memory provided in the motor vehicle, one advantage of using an electronic memory is that it remains in the vehicle even when the vehicle is sold and/or each time the vehicle visits the service station. This electronic memory is available for saving the service measure and/or maintenance measure by a service technician at the service station. The contents of the electronic memory may be output, e.g., for the owner of the vehicle, via a display provided in the vehicle and/or a vehicle computer for control purposes and/or other purposes, e.g., for a sales discussion regarding the vehicle.

One advantage of using a chip card is that the documentation of service measures and/or the contents of the electronic memory can be observed on a display screen outside of the vehicle, e.g., on the owner's home PC using a chip card reader.

As an alternative or in addition, the documentation of service measures in one embodiment of the invention may take place immediately following the service measure in a device outside of the vehicle, in particular, with the manufacturer of the vehicle. A check of the correspondence between the two hash values is performed in this way in a secure and reliable environment by the vehicle manufacturer or by an institution commissioned by the manufacturer.

As an alternative or in addition, one embodiment of the invention provides for the service measures, the date of the service measures, the current kilometer reading at the time of the service measure and the certificate to be stored in plain text in the electronic memory. This permits adequate documentation of service measures in an incorruptible form.

As an alternative or in addition, in one embodiment of the invention, the hash value may be generated and/or encrypted using the personal key of a service station and/or a service technician, using a chip card in which at least the personal key has been stored in a secure manner to prevent unauthorized access.

When using the known public key method and/or when using a personal key, the authenticity of the data of the service measures can be reliably ensured by a complementary public key and a certificate with which a so-called trust center confirms that the public key has been assigned to the key holder specified in the certificate. It is thus possible to determine without a doubt what has been performed on the vehicle and who has confirmed what, when, which service station or the like.

As an alternative or in addition, in another embodiment of the invention, the contents of the electronic memory, in particular the service measures saved in the electronic memory, are displayed on a screen provided in the motor vehicle and/or on the screen in a service station and/or at a vehicle dealer's location and/or on the screen of a PC in the household area.

As a result of these measures, the documentation can be displayed in a flexible manner whenever needed.

As an alternative or in addition, in one embodiment of the invention, the renewed formation of the hash value, the decryption of the encrypted hash value already formed and the comparison of the two hash values are performed in the motor vehicle and/or in the service station and/or at the vehicle dealer's location and/or at the vehicle manufacturer's location or an organization working for the manufacturer and/or on a computer (e.g., PC) in a household area.

In this way, verification of the authenticity of the documentation of service measures can be offered to the owner of the vehicle in a flexible manner in the form of an “electronic checkbook” for the vehicle.

The invention also makes it possible to provide a device for documentation of service measures on a vehicle using an electronic memory in which the device performs the method according to any one of the preceding embodiments.

Furthermore, the invention also makes it possible to provide a computer program product for documentation of service measures on a vehicle using an electronic memory, whereby the computer program product triggers the execution of a method according to any one of the preceding embodiments.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for documentation of service measures on a motor vehicle using an electronic memory, comprising the acts of:
generating a hash value of input data which identifies at least one concrete service measure,
encrypting the hash value using a personal key as part of a public key method, and
inputting the input data, the encrypted hash value and a certificate including in plain text at least a public key complementary to the personal key and data on a key holder into the electronic memory.

2. The method as claimed in claim 1, wherein, for verifying the authenticity of the input data, the method further comprises the acts of:
generating another hash value of the input data identifying the concrete service measure,
decrypting the encrypted hash value entered into the electronic memory using the public key specified in the certificate, and
comparing the decrypted hash value with the another hash value,
wherein the input data is considered to be authentic if the two hash values match.

3. The method as claimed in claim 1, wherein the hash value comprises a bit cross-check sum of the input data for the concrete service measure.

4. The method as claimed in claim 1, wherein the input data comprises a current date and a current kilometer reading of the motor vehicle at a point in time of the service measure, and the hash value at least the current date and the current kilometer reading are stored in the electronic memory.

5. The method as claimed in claim 1, wherein the electronic memory is provided in a control unit of the motor vehicle, in a removable mobile data carrier in the motor vehicle comprising a chip card, or in a device external to the motor vehicle at a manufacturer's location.

6. The method as claimed in claim 1, wherein the service measure, a date of the service measure, a current kilometer reading at the point in time of the service measure and the certificate in plain text are stored in the electronic memory.

7. The method as claimed in claim 1, wherein the creation or encryption of the hash value using the personal key of a service station or a service technician is performed using the personal key, using a chip card in which at least the personal key is stored and secured against unauthorized access.

8. The method as claimed in claim 1, wherein the service measures saved in the electronic memory are displayed on a display screen provided in the motor vehicle or on a screen in a service station or at a vehicle dealer's location or on a screen of a computer in a household area.

9. The method as claimed in claim 1, wherein the another hash value, the decryption of the encrypted hash value and the comparison of the two hash values are performed in the motor vehicle or in a service station or at a vehicle dealer's location or by a computer in a household area.

10. The method as claimed in claim 2, wherein the hash value comprises a bit cross-check sum of the input data for the concrete service measure.

11. The method as claimed in claim 2, wherein the input data comprises a current date and a current kilometer reading of the motor vehicle at a point in time of the service measure, and the hash value at least the current date and the current kilometer reading are stored in the electronic memory.

12. The method as claimed in claim 2, wherein the electronic memory is provided in a control unit of the motor vehicle, in a removable mobile data carrier in the motor vehicle comprising a chip card, or in a device external to the motor vehicle at a manufacturer's location.

13. The method as claimed in claim 2, wherein the service measure, a date of the service measure, a current kilometer reading at the point in time of the service measure and the certificate in plain text are stored in the electronic memory.

14. The method as claimed in claim 1, wherein the creation or encryption of the hash value using the personal key of a service station or a service technician is performed using the personal key, using a chip card in which at least the personal key is stored and secured against unauthorized access.

15. The method as claimed in claim 2, wherein the service measures saved in the electronic memory are displayed on a display screen provided in the motor vehicle or on a screen in a service station or at a vehicle dealer's location or on a screen of a computer in a household area.

16. The method as claimed in claim 2, wherein the another hash value, the decryption of the encrypted hash value and the comparison of the two hash values are performed in the motor vehicle or in a service station or at a vehicle dealer's location or by a computer in a household area.

17. The method as claimed in claim 3, wherein the input data comprises a current date and a current kilometer reading of the motor vehicle at a point in time of the service measure, and the hash value at least the current date and the current kilometer reading are stored in the electronic memory.

18. The method as claimed in claim 3, wherein the electronic memory is provided in a control unit of the motor vehicle, in a removable mobile data carrier in the motor vehicle comprising a chip card, or in a device external to the motor vehicle at a manufacturer's location.

19. A device for documentation of service measures on a motor vehicle, comprising:
a control unit configured to generate a hash value of input data which identifies at least one concrete service measure and encrypt the hash value using a personal key as part of a public key, and
an electronic memory configured to store the input data, the encrypted hash value and a certificate containing in plain text at least the public key complementary to the personal key and data on a key holder.

20. A computer program product for documentation of service measures on a motor vehicle using an electronic memory, the computer program product stored on a computer readable medium and adapted to perform operations comprising:
generating a hash value of input data which identifies at least one concrete service measure,
encrypting the hash value using a personal key as part of a public key method, and
inputting the input data, the encrypted hash value and a certificate including in plain text at least a public key complementary to the personal key and data on a key holder into the electronic memory.
